(19) United States
(12) Patent Application Publication
(10) Pub. No.: US 2007/0202265 A1
(43) Pub. Date: Aug. 30, 2007

(54) Process for Manufacturing a Polarized Poly(thio)urethane Optical Lens

(75) Inventor: Ronald Berzon, St. Petersburg, FL (US)

Correspondence Address: FULBRIGHT & JAWORSKI L.L.P., 600 CONGRESS AVE., SUITE 2400, AUSTIN, TX, 78701, US

(73) Assignee: Essilor International ( Compagnie Generale Generale d'Optique), Charenton (FR)

(21) Appl. No.: 11/678,180

(22) Filed: Feb. 23, 2007

Related U.S. Application Data
(60) Provisional application No. 60/776,251, filed on Feb. 24, 2006.

(51) Int. Cl. B05D 7/00

(52) U.S. Cl. 427/407.1

(57) ABSTRACT

The invention relates to a process for manufacturing a polarized poly(thio)urethane-based optical article comprising the steps of disposing a polarizing film or wafer in a molding cavity of a two part mold assembly; pouring a polymerizable composition comprising at least one polyiso(thio)cyanate monomer and at least one polyol and/or polythiol; or a mixture of at least one liquid NCO and/or NCS terminated poly(thio)urethane prepolymer and at least one liquid OH and/or SH terminated poly(thio)urethane prepolymer; with the proviso that the polymerizable composition has a ratio of NH₂ functionalities to the NCO or NCS functionalities of less than 0.9; polymerizing the composition under such conditions that a hard gel is obtained in less than 30 minutes; completing the polymerization; and opening the two part mold so as to recover the bubble free optical article.

### CROSS-REFERENCE TO RELATED APPLICATIONS

This application claims priority to U.S. Provisional Application No. 60/776,251 filed Feb. 24, 2006, the entire text of which disclosure is specifically incorporated by reference herein without disclaimer.

### BACKGROUND OF THE INVENTION

1. Field of the Invention

The present invention relates to a process for manufacturing a polarized poly(thio)urethane optical lens, in particular a polarized ophthalmic lens such as a spectacle lens.

2. Description of the Related Art

Polarized lenses are known in the art and their manufacture methods have been described in numerous patents such as, for example, U.S. Pat. No. 6,220,703B1 and US 2001/0028435A1.

Typically, polarized thermoset lenses are manufactured by either adhering or bonding a polarized film or wafer to lens substrate surface or positioning a polarized film or wafer between the two mold parts of a lens mold assembly, pouring a polymerizable composition in the mold cavity between the two mold parts and then curing the polymerizable composition. There is thus obtained a sandwich wherein the polarized film is embedded into the cured lens material.

The polymerizable compositions typically used for implementing the above processes are radically or condensation polymerizable compositions.

There are numerous problems linked with the implementation of the above process.

Regarding optical quality, the lens material of the resulting lens must be defect-free, which means that no flow-lines and/or bubbles should be present in the final lens. As, in the above process, the lens mold cavity is divided in two very thin cavities delimited by each surface of the polarized film and each correspondent facing surface of the mold parts, filling of the mold cavity with the polymerizable composition is rendered more difficult. Additionally, optical properties of the polarized film have to be preserved during the polymerization (curing) step. These optical properties can be affected by high local temperatures due to the exothermal polymerization reaction, or internal stresses due to shrinkage of the polymerization composition.

Also, problems of adhesion between the polarized film and the lens material often occur. For example, U.S. Pat. No. 6,220,703B1 addresses the problem of adhesion between a polarizing polyethylene terephtalate (PET) film or laminated polyvinyl alcohol (PVOH) film or wafer and the lens material.

The inventors noticed that when the lens material is a poly(thio)urethane-based material, in particular a polythiourethane (PTU), using the usual thermal polymerization process with tin catalyst (in which curing lasts more than 15 hours) leads to lenses having a high level of bubbles, totally unacceptable for optical use.

In this patent application, poly(thio)urethane means polyurethane, generally having a refractive index around 1.50 and slightly higher, or polythiourethane (PTU).

In the same way, polyiso(thio)cyanates means polyisocyanates or polyisothiocyanates, the polyisocyanates being preferred for implementing the invention.

PTU, are of major interest in the optical technical field due to their high refractive index, typically having a refractive index n_{D}²⁵ of 1.60, preferably of 1.65 and more preferably of 1.67 or more.

US 2001/0028435 A1 discloses a process for making a polarized polyurethane-based lens which comprises reacting a polyurethane prepolymer obtained by reacting one equivalent of a polyester glycol or a polyether glycol with 4,4′-methylenebis(cyclohexyl isocyanate) in an equivalent ratio of 2.5 to 4.5 NCO for each OH with an aromatic curing agent in an equivalent ratio of 0.9 to 1.1 NH₂/NCO. The reaction mixture is said to exothermically react very quickly and to begin to solidify within 30 seconds. The fast reaction and cure of the reaction mixture create problems and necessitate specific measures to remove entrapped gases. Despite the choice of a specific reaction mixture and specific molding measures, most of the resulting lenses were unacceptable.

Thus, the aim of the present invention is to provide a process for making a polarized poly(thio)urethane-based optical article, such as an ophthalmic lens, remedying to the drawbacks of the prior art processes.

More specifically, one object of the present invention is to provide a process for making a polarized poly(thio)urethane-based optical article, such as an ophthalmic lens, which is free from bubbles.

Another object of the present invention is to provide a process for making an optical article as defined above which is not limited to a specific reaction mixture.

A further object of the present invention is to provide a process for making an optical article as defined above which is not limited to a specific molding process but can be implemented using classical molding processes.

Still another object of the present invention is to provide a process for making an optical article as defined above which is not limited to specific polarizing films or wafers.

### SUMMARY OF THE INVENTION

The present invention provides a process for manufacturing a poly(thio)urethane-based optical article comprising the steps of:
disposing a polarizing film or wafer in a molding cavity of a two part mold assembly;
pouring a polymerizable composition comprising:
   a) at least one polyiso(thio)cyanate monomer and at least one polyol and/or polythiol; or
   b) a mixture of at least one liquid NCO and/or NSC terminated poly(thio)urethane prepolymer and at least one liquid OH and/or SH terminated poly(thio)urethane prepolymer;
   c) with the proviso that the polymerizable composition has a ratio of NH₂ functionalities to the NCO or NCS functionalities of less than 0.9 and preferably is free of NH₂ functionalities;
polymerizing the composition under such conditions that a hard gel is obtained in less than 30 minutes, preferably less than 20 minutes and even better less than 10 minutes;
completing the polymerisation;
opening the two part mold and recovering the bubble free optical article.

### DESCRIPTION OF THE FIGURES

FIG. 1 is a schematic representation of a two part mold assembly which can be used for molding polarized ophthalmic lenses according to the invention, and

FIG. 2 is a Fourier Transform Infra Red Spectrum (FTIR) of the polarizing wafer used in the example 1 at different times of the hydrolysis treatment thereof (with NaOH).

FIG. 3 is a Fourier Transform Infra Red Spectrum (FTIR) of the polarizing wafer used in example 2 showing also the peak corresponding to OH groups after NaOH hydrolysis and drying of the polarizing wafer.

### DETAILED DESCRIPTION OF THE INVENTION

By formation of a hard gel, one means that the resulting polymerized composition is self-supporting, i.e. is able to withstand its own shape without deformation.

Preferably, the polymerized composition is self-supporting in the mold assembly when the annular closure of the two part mold assembly (gasket or tape) has been removed.

The iso(thio)cyanate monomers useful in the process of the present invention can be any iso(thio)cyanate compound having at least one —NCX group, where X is O or S, preferably S and at least another reactive group capable to react with a OH or SH group.

Preferably, the iso(thio)cyanate monomer comprises two or more NCX groups, and most preferably two NCX groups. The most preferred iso(thio)cyanates are diisocyanates.

The preferred polyisocyanate or isothiocyanate monomers are those having the formulae:

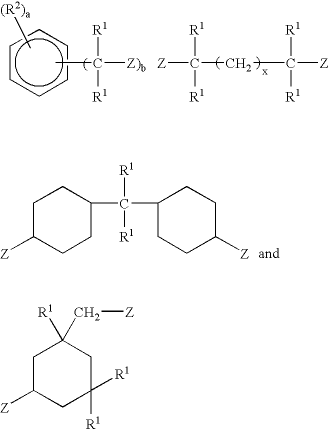

wherein

R¹ is independently H or a C₁-C₅ alkyl group, preferably CH₃ or C₂H₅;

R² is H, an halogen, preferably Cl or Br, or a C₁-C₅ alkyl group, preferably CH₃ or C₂H₅;

Z is —N═C═X, with X being O or S, preferably O;

a is an integer ranging from 1 to 4, b is an integer ranging from 2 to 4 and a+b≦6; and

x is an integer from 1 to 10, preferably 1 to 6.

Among the preferred polyisocyanate or isothiocyanate monomers there may be cited tolylene diisocyanate or diisothiocyanate, phenylene diisocyanate or diisothiocyanate, ethylphenylene diisoocyanate, isopropyl phenylene diisocyanate or diisothiocyanate, dimethylphenylene diisocyanate or diisothiocyanate, diethylphenylene diisocyanate or diisothiocyanate, diisopropylphenylene diisocyanate or diisothiocyanate, trimethylbenzyl triisocyanate or triisothiocyanate, xylylene diisocyanate or diisothiocyanate, benzyl triiso(thio)cyanate, 4,4′-diphenyl methane diisocyanate or diisothiocyanate, naphtalene diisocyanate or diisothiocyanate, isophorone diisocyanate or diisothiocyanate, bis(isocyanate or diisothiocyanate methyl)cyclohexane, hexamethylene diisocyanate or diisothiocyanate and dicyclohexylmethane diisocyanate or diisothiocyanate.

There can be used a single polyisocyanate or isothiocyanate monomer or a mixture thereof.

The polythiol monomer may be any suitable polythiol having two or more, preferably two or three thiol functions.

The polythiol monomers can be represented by formula:

R′(SH)_{n′}

in which n′ is an integer from 2 to 6 and preferably 2 to 3, and R′ is an organic group of valency equal to n′.

Useful polythiol monomers are those disclosed in EP-A-394. 495 and U.S. Pat. No. 4,775,733 and the polythiols corresponding to the following formulas:

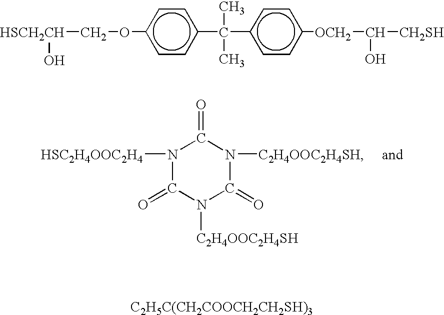

Among the preferred polythiol monomers there may be cited aliphatic polythiols such as pentaerythritol tetrakis mercaptoproprionate, 1-(1′mercaptoethylthio)-2,3-dimercaptopropane, 1-(2′-mercaptopropylthio)-2,3-dimercaptopropane, 1-(-3′mercaptopropylthio)-2,3-dimercaptopropane, 1-(-4′mercaptobutylthio)-2,3-dimercaptopropane, 1-(5′mercaptopentylthio)-2,3-dimercapto-propane, 1-(6′-mercaptohexylthio)-2,3-dimercaptopropane, 1,2-bis(−4′-mercaptobutylthio)-3-mercaptopropane, 1,2-bis(−5′mercaptopentylthio)-3-mercaptopropane, 1,2-bis(-6′-mercaptohexyl)-3-mercaptopropane, 1,2,3-tris(mercaptomethylthio)propane, 1,2,3-tris(-3′-mercaptopropylthio)propane, 1,2,3-tris(-2′-mercaptoethylthio)propane, 1,2,3-tris(-4′-mercaptobutylthio)propane, 1,2,3-tris(-6′-mercaptohexylthio)propane, methanedithiol), 1,2-ethanedithiol, 1,1-propanedithiol, 1,2-propanedithiol, 1,3-propanedithiol, 2,2-propanedithiol, 1,6-hexanethiol-1,2,3-propanetrithiol, and 1,2-bis(-2′-mercaptoethylthio)-3-mercaptopropane.

The most preferred polythiol is 3-(2-sulfanylethylthio)-2-(2-sulfanylethylthio)propane-1-thiol.

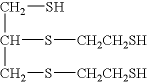

Preferably the polythiols have a viscosity at 25° C. of 2.10⁻¹ Pa·s or less, more preferably 10⁻¹ Pa·s or less and ideally of 0.5. 10⁻¹ Pa·s or less.

Polyurethane prepolymers having isocyanate or isothiocyanate (NCX where X is O or S) end groups, preferably isocyanate end groups (component A) of the polymerizable compositions of the present invention typically have a viscosity at 25° C. of 0.02 to 0.4 Pa·s.

Polyurethane prepolymers having hydroxyl (OH) or thiol (SH) end groups, preferably thiol end groups (component B) of the polymerizable compositions of the present invention typically have a viscosity at 25° C. of 0.2 to 2.0 Pa·s.

Preferably, the first component A will have a molar ratio of the isocyanate or isothiocyanate groups to the thiol or hydroxyl groups NCX/SH or OH ranging from 4:1 to 30:1, preferably 6:1 to 10:1, whereas the second component B will have a molar ratio of the thiol or hydroxyl groups to the isocyanate or isothiocyanate groups SH or OH/NCX ranging from 4:1 to 30:1, preferably 6:1 to 10:1 Components A and B are prepared by polymerizing mixtures of required amounts of polyisocyanate and/or polyisothiocyanate monomers and/or polythiols or polyols monomers.

The mixture polythiol/polyiso(thio)cyanate from which prepolymer B is obtained may comprise 0 to 30% by weight of at least one polyol. Preferably, no polyol is used.

Polymerization methods are classical, however the amounts of polyisocyanate or polyisothiocyanate monomers and polythiol or polyol monomers in the reaction medium shall be adapted in each case in such a way that the NCX/SH or OH ratio for the mixture polyisocyanate or polyisothiocyanate/polythiol or polyol monomers is ranging from 4:1 to 30:1, preferably 6:1 to 10:1 for the obtention of component A and the SH or OH/NCX ratio for the mixture is ranging from 4:1 to 30:1, preferably 6:1 to 10:1 for the obtention of component B. Typically, components A and B can be prepared through classical thermal polymerization including induction and infra-red heating.

Preferably, both components A and B are prepared without the use of a catalyst system since it allows better control of the polymerization reaction and results in prepolymers of high stability in time, which can be safely stored.

However, they can be prepared using a catalyst or catalyst system as described hereinunder.

Preparation of prepolymer having thiol end groups have already been described in U.S. Pat. No. 5,908,876. Similar process can be used to prepare components B of the present invention.

Component A of the present invention can be prepared in a similar manner but with the required ratio of polyisocyanate or polyisothiocyanate and polythiol monomers in order to obtain polythiourethane prepolymer having isocyanate or isothiocyanate end groups.

The polymerizable compositions of the invention usually also comprise a polymerization catalyst or catalyst system, preferably an anionic catalyst or catalyst system.

The preferred catalysts are transition metals and ammonium salts of acids, these salts fulfilling the condition 0.5≦pKa≦14.

These preferred latter salts are defined as salts of formula:

Mₘ^{P+}Yₙ⁻

wherein,

M^{p+} is a cation selected from the group consisting of alkaline metals, alkaline earth metals, transitions metals and ammonium groups of formula NR⁺₄ in which R is an alkyl radical,

Y⁻ is an anion such that the corresponding acid YH has a pKa fulfilling the condition 0.5≦pKa≦14,

p is the valency of the cation, and

n=m×p.

Preferably, the catalyst consists solely in the salt or a mixture of these salts.

The preferred metallic cation of the salts are Li⁺, Na⁺, K⁺, R^{b+}, Mg²⁺, Ca²⁺, Ba²+ and Al³⁺. The particularly preferred metallic cations are Li⁺, Na⁺ and K⁺ due to their absence of color and solubility in the composition. Transition metals are less preferred because the salts thereof lead to coloured compositions and therefore coloured polymerized resins.

The preferred NR⁺₄ groups are those in which R is a C₁-C₈ alkyl radical and more preferably, a methyl, ethyl, propyl, butyl or hexyl radical.

The salts shall be used in the polymerizable composition in an effective amount, i.e. an amount sufficient to promote the thermal or room temperature polymerization of the composition.

Generally, the salt will be present in amounts ranging, based on the total weight of the polymerizable monomers, from 5 to 2000 parts per million (ppm), preferably 10 to 500 ppm and more preferably 40 to 100 ppm.

Preferably, Y⁻ is an anion such that the corresponding acid YH which fulfills the condition 0.5≦pKa≦10 and more preferably 0.5≦pKa≦8.

Preferably, the anion Y⁻ is selected from the group consisting of thiocyanate, carboxylate, thiocarboxylate, acetylacetonate, diketone, acetoacetic ester, malonic ester, cyanoacetic ester, ketonitrile and anion of formula RS⁻ wherein R is a substituted or non-substituted alkyl group or phenyl group.

Preferably, the alkyl group is a C₁-C₆ alkyl group, such as methyl, ethyl and propyl.

The preferred anions Y⁻ are SCN⁻, acetylacetonate, acetate, thioacetate, formate and benzoate.

The preferred salt is KSCN.

Generally, the salt will be present in amounts ranging, based on the total weight of the polymerizable monomers, from 0.001 to 2.5%, preferably 0.001 to 1%.

Electron-donor compounds may be used in combination with the salt and are preferably selected from the group consisting of acetonitrile compounds, amide compounds, sulfones, sulfoxides, trialkylphosphites, nitro compounds, ethyleneglycol ethers, crown ethers and kryptates.

Examples of acetonitrile compounds are:

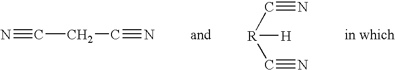

R is an alkyl group, preferably a C₁-C₆ alkyl group such as methyl, ethyl, propyl, butyl.

The amide compounds may be primary, secondary or tertiary amide compounds.

The trialkylphosphites and triarylphosphites may be represented by formula:

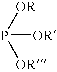

in which R, R′, R′″ are either an alkyl group, preferably a C₁-C₆ alkyl group or an aryl group such as a phenyl group. Preferred are trialkylphosphites, for example (C₂H₅O)₃P.

Electron-donor compounds may also be selected from crown ethers and kryptates.

These cyclic molecules are usually chosen to exhibit a good compromise between the heteroatom or metal size and the “cage” size, i.e. between the number of heteroatoms and the size and the “cage” size, i.e. between the number of heteroatoms and the size of the cycle.

The preferred crown ethers and kryptates may be represented by the following formulae:

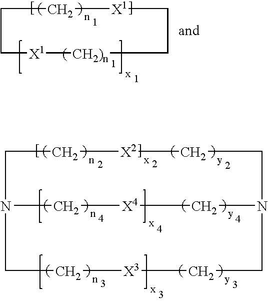

wherein X¹ represents O, S or NH, x, is an integer from 3 to 6, preferably from 3 to 4, n₁ is 2 or 3,

X², X³ and X4 represent O, S, n₂, n₃, n₄, Y₂, y₃, y₄ are 2 or 3 and x₂, X₃, X4, are 2 or 3.

Among the preferred crown ethers and kryptates there may be cited the following compounds:

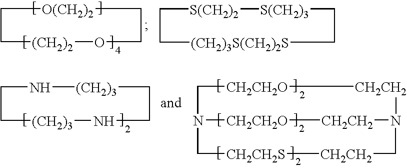

The electron-donor compounds are present, based on the total weight of the polymerizable monomers in amounts ranging from 0 to 5% by weight, preferably 0 to 1% by weight, and most preferably are crown ethers such as 18-crown-6, 18-crown-7, 15-crown-5 and 15-crown-6.

The polymerizable composition of the present invention preferably comprises a solvent for promoting the dissolution of the salt catalyst.

Any polar organic solvent can be used such as acetonitrile, tetrahydrofurane or dioxane. Other suitable solvents are methanol, ethanol, thioethanol, acetone, acetonitrile and 3-methyl-2-butene-1ol.

The amount of solvent is generally kept below 2% by weight, based on the total weight of the polymerizable monomers present and preferably between 0 and 0.5% by weight, to avoid haze and bubbling.

The polymerizable composition according to the invention may also include additives which are conventionally employed in polymerizable compositions intended for moulding optical articles, in particular ophthalmic lenses, in conventional proportions, namely inhibitors, dyes, photochromic agents, UV absorbers, perfumes, deodorants, antioxidants, anti-yellowing agents and release agents.

The perfumes allow the odour of the compositions to be masked, in particular during surfacing or routering operations.

In particular, usual UV absorbers such as those commercialized under the trade names UV 5411®, UV 9®, Tinuvin400®, Tinuvin P®, Tinuvin 312®, Seesorb 701® and Seesorb 707® may be used in amounts generally up to 2% by weight of the total polymerizable monomers weight.

Also, the compositions of the invention preferably comprise a release agent in an amount up to 0.1% by weight of the total polymerizable monomers weight.

Among the release agents there may be cited mono and dialkyl phosphates, silicones, fluorinated hydrocarbon, fatty acids and ammonium salts. The preferred release agents are mono and dialkyl phosphates and mixtures thereof. Such release agents are disclosed inter alia in document U.S. Pat. No. 4,662,376, U.S. Pat. No. 4,975,328 and EP-271.839.

The polarizing films or wafers of the process of the invention are well known in the art and can be any polarizing film or wafer typically used for making polarized optical articles such as ophthalmic lenses.

Polarizing films or wafers may comprise a variety of different constructions and materials. Such constructions include freestanding or non-laminated films, films with removable protective sheeting, films with outer permanent protective coatings or supportive plastic layers and laminated films and wafers.

Among the polarizing films there may be cited poly(ethylene terephtalate) (PET) films and poly(vinyl alcohol) (PVOH) films.

Other polarizing films may include thin, multilayered polymeric materials, combined reflective and dichroïc polarizers, or films of mixed polymeric phases such as those described in U.S. Pat. Nos. 5,882,774; 6,096,375; and 5,867,316.

Among the polarizing wafers there may be cited polycarbonate/PVOH/polycarbonate layered combinations less than 1 mm thick.

Preferably, one uses the polarizing wafers having a thickness higher than 0.10 mm and better between 0.20 and 0.30 mm.

Typically, The PVOH core film has a thickness of 0.01 to 0.02 mm and the two shell layers have a thickness of around 0.13 mm.

Materials other than polycarbonate for the wafer construct may also comprise poly(methyl methacrylate), polystyrene, cellulose acetate butyrate (CAB), cellulose acetate, and cellulose triacetate.

The preferred polarizing wafer is a CAB/PVOH/CAB multilayered combination.

Generally, the polarizing films and wafers are hydrophilic having values of contact angles (static) ranging initially, (i.e. before any hydrolysis treatment) typically from 500 to 75°. In particular, the CAB outer layers of the preferred polarizing wafer are hydrophilic and contain water or traces of water which will react with the polyiso(thio)cyanate, one of the precursors of polythiourethane, and will produce bubbles.

Using the quick polymerization process of the invention avoids this problem. The time to gellation being particularly short, there is no time for the iso(thio)cyanate to react with the moisture.

The polarizing films or wafers may be treated for improving their adhesion to the lens material and/or to functional coatings classically used with ophthalmic lenses, such as, for example, scratch and impact resistant coatings, primer coatings and anti-reflective coatings.

Such treatments include mechanical roughening, physical cleaning, chemical surface modification, plasma activation and coating of the polarizing film or wafer.

Preferred treatment is a chemical treatment comprising immersing the film or wafer in a basic or acidic solution, such as but not limited to NaOH, KOH, HCl or H₂NO3 solution, rinsing and drying. These acids or bases can be used at volumetric or mass levels of 0.001% to 100% (but preferably lower) or normal concentrations of at least 0.001N or greater. Treatment with 5% NaOH is preferred.

Treatment with NaOH solution is preferred.

The films or the wafers that are preferably used in the process of the invention are those that give bubbles visible by the naked eye after a casting polymerization process wherein the wafer is put between two lens mold parts and cast polymerized in contact of a polythiourethane composition poured between the two mold parts and whose polymerization cycles lasts at least 15 hours, more preferably at least 8 hours.

The invention has several advantages:

It is not necessary to dry the polarized films or wafers (in order to suppress bubbles) when using the short cycle polymerization of the invention.

In other words, the polarized films or wafers can contain traces of water and still be usable in the process of the invention and provides a very good adhesion.

It is possible to use polarized films or wafers that have been rendered more hydrophilic in surface, and consequently that provides a better adhesion.

In the examples below, the following mold assembly, polarizing films and wafers, polarizing film and wafer treatments, polymerizable compositions and methods of preparation, and adhesion test were used, unless otherwise stated.

### Mold Assembly

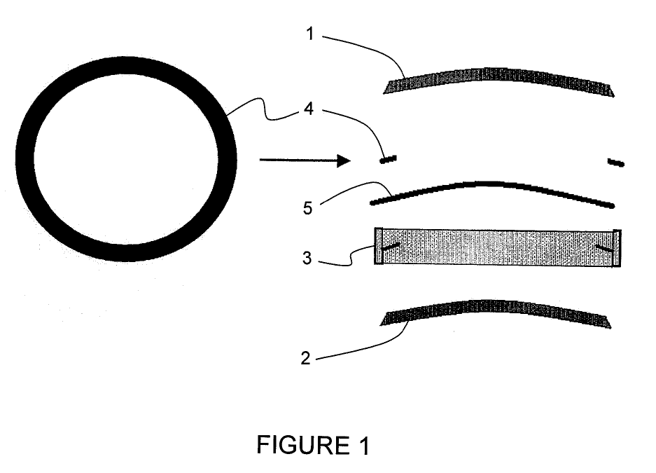

The mold assembly is schematically represented in FIG. 1 and comprises 6-base 77 mm piano glass concave (CC) and convex (CX) mold parts 1 and 2, and an annular gasket 3. This mold assembly is typically used for producing 2.0 mm center thickness (CT) lenses. In order to fabricate a polarized lens, a 1.0 mm CT gasket 3 and a 1.0 mm thick annular rubber spacer 4 are needed to create a separation or void between the convex surface of the polarizing film or wafer 5 and the concave mold part 1 surface.

The polarizing film or wafer 5 is first placed into the top of gasket 3 with its convex surface upwardly oriented. Then rubber spacer 4 is placed on top of the polarizing film or wafer. Finally, the CC mold part 1 is placed on top of the rubber spacer with its concave surface downwardly oriented, and the CX mold part 2 is placed into the bottom side of gasket 3 with its convex surface upwardly oriented.

The polymerizable composition is then introduced within the void created by means of spacer 4 between the polarizing film or wafer 5 and CC mold part 1 through filling means (not represented) provided in gasket 3.

### Polarizing Wafer

Unless otherwise stated, all the polarizing wafers used in the examples are 77 mm polarized wafers (IP38-01C) obtained from International Polarizer in Marlborough, Mass. USA. These particular wafers are composed of several layers consisting of a delicate poly(vinyl alcohol) polarizing layer supported on both sides with cellulose acetate butyrate (CAB) layers. This design is referred to as a fully laminated polarized wafer.

The CAB layers are of hydrophilic nature, having values of contact angle of about 66 to 72°.

### Hydrolysis of Polarizing Wafer

To improve adhesion of the polarizing wafer to the cured polymerizable composition constituting the lens material, unless otherwise stated, the wafer is chemically treated by immersing the wafer into a 5% NaOH or a 1N HCl aqueous solution. Immersion time and temperature may vary widely depending upon the nature of the wafer and the polymerizable composition. Typically, immersion is effected at a temperature ranging from 20° C. (room temperature) to 50° C., preferably about 40° C. and lasts up to 1 hour, preferably about 30 minutes.

The wafer is then rinsed with de-ionized water for about 15 seconds, thereafter placed in warmed de-ionized water for 1 minute and finally rinsed again with de-ionized water for 15 seconds.

Then, the wafer can be dried. Drying temperature and time may vary widely. The hydrolyzed CAB layers have increased in their hydrophilic nature, having values of contact angle of about 30-35°.

FTIR (Fourier Transform Infrared Spectroscopy) was used to monitor both hydrolysis and water absorption. Hydrolysis was monitored at wave numbers of 3000 to 3600 cm⁻¹ and water absorption was monitored at wave number of 1634 cm⁻¹.

Fast Cure High refractive index (around 1.67) Polymerizable Composition

A fast cure polymerizable composition leading to a polythiourethane lens material having a refractive index n_{D}²⁵ of about 1.67 is composed of two main components. The first component A is comprised of a polythiourethane prepolymer having isocyanate (NCO) end groups. A second component B is comprised of a polythiourethane prepolymer having thiol (SH) end groups. The prepolymers A and B are synthesized using xylylene diisocyanate (XDI) and 3-(2-sulfanylethylthio)-2-(2-sulfanylethylthio)propane-1-thiol as described in detail below.

Then, a catalyst solution comprising 0.191 g of 18-crown-6, 0.048 g of KSCN and 0.318 g of thioethanol is added to component B.

First component A and second component B incorporating the catalyst solution are mixed together in a weight ratio component A/component B of 10/9.39. The resulting mixture has a viscosity at 25° C. of about 0.1 to 0.3 Pa·s 0.3 Pa·s. The mixture gellifies within 1 to 10 minutes, preferably within 3-5 minutes at room temperature.

Preparation of Polythiourethane Prepolymer Having Isocyanate End Groups (Component A)

In a reactor equipped with a condenser, a thermal probe and an agitator there is charged a determined amount of xylylene diisocyanate (XDI). The polyisocyanate monomer is then heated up to 115° C. Then, 3-(2-sulfanylethylthio)-2-(2-sulfanylethylthio)propane-1-thiol. is introduced and mixed with the polyisocyanate in an amount such that the molar ratio of the isocyanate functions to the thiol functions number

$$\frac{NCO}{SH}$$

is 8:1.

After heating between 3 to 4.5 hours the reaction is complete.

Prepolymer is then cooled and when prepolymer temperature reaches 35° C. (+/−5° C.), the prepolymer is transferred into an appropriate drum, tapped with inert gas (nitrogen or argon) and stored in a cold room.

Final prepolymer with isocyanate end groups (component A) has a viscosity at 25° C. of 0.071 Pa·s.

Preparation of Polythiourethane Prepolymer Having Thiol End Groups (Component B)

In a reactor equipped with a condenser, a thermal probe and an agitator there is charged a determined amount of 3-(2-sulfanylethylthio)-2-(2-sulfanylethylthio)propane-1-thiol.

The polythiol monomer is then heated to 90° C. Then, xylylene diisocyanate (XDI) is introduced and mixed with the polythiol in an amount such that the molar ratio of the thiol groups to the isocyanate groups

$$\frac{SH}{NCO}$$

is 8:1.

Reaction is completed within 3 hours. End of reaction is indicated by temperature reaching a peak and returning to 90° C. (+/−2° C.).

Prepolymer is then cooled and when prepolymer temperature reaches 35° C. (+/−5° C.), the prepolymer is transferred to an appropriate drum, topped with inert gas (nitrogen or argon) and stored in a cold room.

Final prepolymer with thiol end groups (component B) has a viscosity at 25° C. of 0.543 Pa·s.

### High Index Polythiourethane Compositions

Long cure thiourethane compositions leading to a polythiourethane lens material having a refractive index n_{D}²⁵ of 1.6 are composed of two main monomeric components. The first monomeric component A′ is XDI and the second monomeric component B′ is pentaerythritol tetramercaptopropionate. The monomeric components are mixed together in the proportions indicated in the examples and with additives and catalysts as specified in the examples.

The monomer blends are prepared according to the following general procedure:

1. A mixing vessel is charged with a polythiol flowing into the reactor under vacuum. The contents of the reactor are maintained between −10° and 20° C. during batch preparation and mold filling. Preferably the temperature is between 0° C. to 20° C., and most preferably between 5° C. to 15° C.

2. The total quantity of diisocyanate required is calculated. It is the total amount required to adjust the mole ratio of NCO to OH+SH groups.

3. Between 70% and 80% of required diisocyanate is added to the reactor. The remaining diisocyanate is used to pre-mix the release agent, optional UV absorber, and catalyst into the vessel.

4. Formulations without UV absorber: approximately 15% to 30% of diisocyanate is required for each of two additive pre mixes. The diisocyanate used in each additive premixes is: (total quantity of diisocyanate needed for monomer batch minus amount diisocyanate added in step 3)/2. If an optional UV absorber is added, a separate additive premix is used for this addition. In this case, approximately 5% to 10% of diisocyanate is required for each of three additive pre-mixes. The diisocyanate used in each additive premix is: (total quantity of diisocyanate needed for monomer batch minus amount diisocyanate added in step 3)/3.

Additive pre mix #1:

5. The quantity of diisocyanate calculated in step 4 is placed in a suitable flask with gentle agitation under dry nitrogen purge. A quantity of 45-55 wt % mono to di butyl phosphate mixture totalling 0.2% of the monomer batch weight is slowly added to the flask. The phosphate mixture must completely dissolve. At this time a quantity of C8-C18 mono- and di-alkyl phosphates totalling 600 ppm of the monomer batch size is slowly added. After this addition is completely dissolved, the contents of the flask are added to the reactor under vacuum. The phosphates described are preferably added separately in this order. Simultaneous addition or reversal of order of addition may result in cloudy lenses.

Additive pre mix #2:

6. Using the same procedure as above, a quantity of UV absorber based on monomer batch size is added to the flask, and subsequently, the reactor. To ensure clear, transparent lenses, the UV absorber is preferably added separately from the phosphates and the catalyst.

Additive pre mix #2 (or #3 if UV absorber):

7. Using the same procedure as in step #5, a quantity of catalyst based on the monomer batch size is added to the flask, and subsequently, the reactor. The catalyst is preferably added separately from the phosphates and UV absorber, since it can induce the diisocyanate to react undesirably with either component.

8. The mixture is allowed to mix under vacuum in the reactor. Mixing time is generally 0.5 to 8 hours, preferably 0.5 to 4 hours, and most preferably 1 to 2 hours. The absolute pressure in the reactor is generally 1 to 100 torr, preferably 1 to 50 torr, and most preferably 1 to 10 torr.

9. After mixing is complete, the molds are filled from the monomer mixture in the reactor.

10. The molds are placed in different curing cycles of 10 to 100 hours in length. The initial starting temperatures are generally 0° C. to 30° C. and ramp to 100° C. to 135° C., then finally ramp to 50 to 75° C. before disassembly of molds.

### Adhesion Test

After edging of the lens with an edging machine, this will remove any edge influences that may promote adhesion), the edge of the lens was sharply stricken on a hard surface, such as a table. The lens was examinated for delamination of the layers.

### EXAMPLE 1

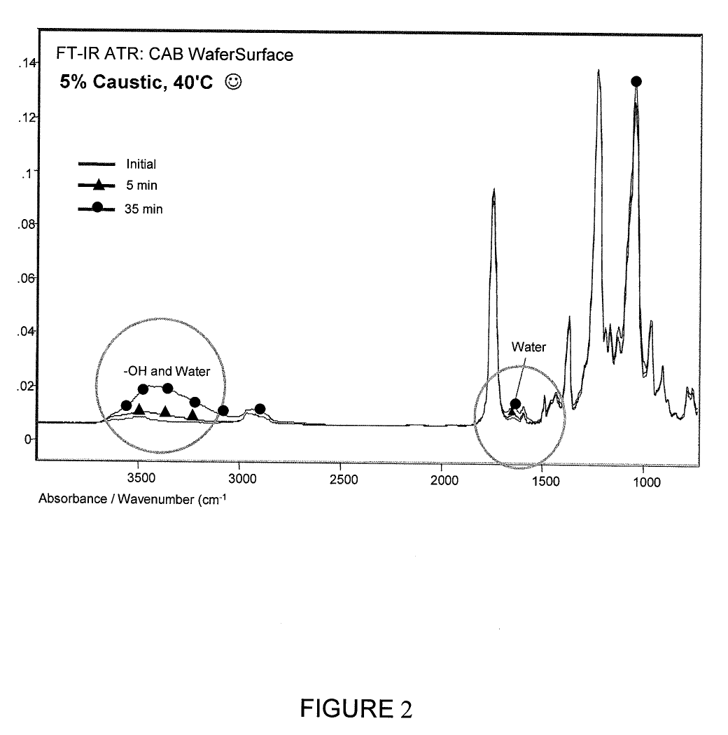

A short cure cycle casting was made using fully laminated polarized wafers that were hydrolyzed at room temperature for 35 minutes in 5% NaOH or 1 N HCl. The wafers (towel dried) were analyzed by FTIR (FIG. 2) showing an increase in peak height with increasing hydrolysis exposure time. The wafers were then oven dried at 40° C. for 1.5 hours.

Molds were assembled positioning the wafers on the gasket using a spacer to leave a gap between the wafer and the CC mold part. The molds were filled with fast cure 1.67 composition described above. The 1.67 composition was gelled in an air oven at 45° C. for 10 minutes. The molds were placed horizontal on a conveyor and heated at 120° C. for about 1-hour duration. The clip and gasket were then removed. The resulting lenses were recovered from the mold and a post cure was completed in an air oven at 120° C. for 2 hours.

The obtained lenses have no bubble visible by the naked eye and have an optical quality.

After edging and striking the lens edge on a hard surface, there was good lamination for the NaOH treated wafers.

### EXAMPLE 2

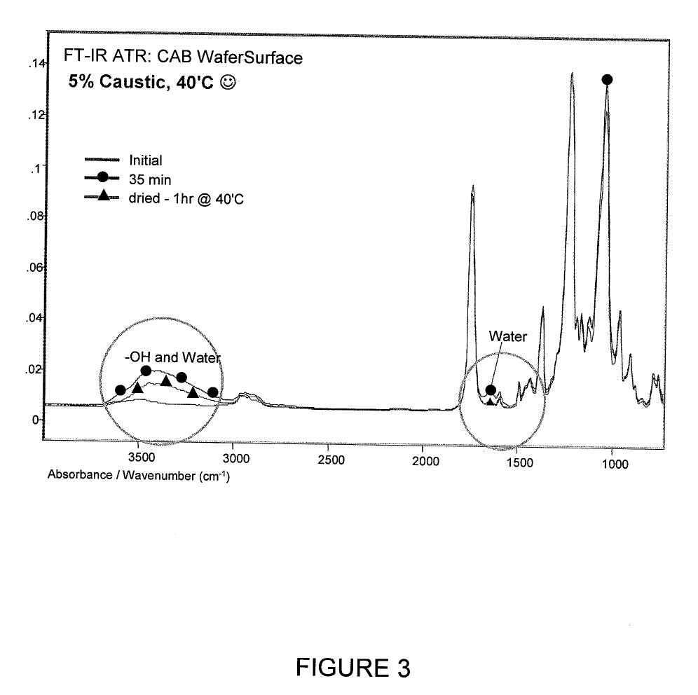

Example 1 is reproduced except the wafers were hydrolyzed at 40° C. and then dried at 40° C. for 1.0 hour. The wafers were analyzed by FTIR (FIG. 3) showing an increase in peak height with increasing hydrolysis exposure time.

The obtained polarized lenses have no bubble visible by the naked eye.

After edging the polarized lenses, and striking the lens edge on a hard surface, it appears that there was good lamination for both the NaOH & HCl treated wafers.

A lens made according to example 2 without polarized film has no bubble.

### COMPARATIVE EXAMPLE 1

In this example, a much longer (18 hours 40 minutes) cure cycle casting was performed with a 1.67 polyurethane composition.

| | Wt % | Wt (g) |
|---|---|---|
| A′ | 51.83 | 129.6 |
| B′ | 48.17 | 120.6 |
| DBP | 0.20 | 0.64 |
| Zelec UN | 0.03 | 0.077 |
| DBC | 80 ppm | 0.0198 |

DBP: dibutylphosphate;
DBC: di-butyl tin dichloride

The ingredients are placed into a side arm erlenmyer flask along with a magnetic stir bar, then capped. The flask is placed onto a magnetic stir plate. A vacuum pump, equipped with a cold trap, is attached to the flask. A vacuum is applied for ˜1-2 hours to remove any dissolved gasses. This method is obvious to one skilled in the arts. The monomer is carefully transferred to a separatory flask, which is used to fill the molds.

A white (meaning transparent in the context of the invention) lens without polarizing film lens was cast or a polarized lens was cast with no surface treatments on the polarized wafer or a polarized lens was cast with a polarized wafer treated by a 5% NaOH hydrolysis at 40° C. for 30 minutes then dried for 1 hour at 45° C.

These lenses were cured in an air oven with a much longer cure cycle as follows: 9 hours at about 30° C. followed by an increase in temperature from 30 to 120° C. in 5 hours and 40 minutes, then maintaining at 120° C. during about 2 hours and finally a decrease of temperature from 120° C. to 60° C. in 2 hours.

A bubble free white lens resulted. The lens cast with a wafer with no surface treatments or hydrolysis, did not yield a lens.

### COMPARATIVE EXAMPLE 2

Comparative example 1 is reproduced except the polymerizable composition used is a mixture of A″ (prepolymer of A′ and B′) and B″ (prepolymer of A′ and B′). A″ is a polythiourethane prepolymer having isocyanate end groups. B″ is composed of a polythiourethane prepolymer having thiol (SH) end groups. Lens polymerizable compositions were prepared and cured following the procedure of comparative example 1.

A white lens was cast with no polarizer or a polarized lens was cast with no surface treatments for the polarizer or a polarized lens was cast with the polarized lens being treated according to the following steps: 5% NaOH hydrolysis at 40° C. for 30 minutes then dried for 1 hour at 45° C.

As said above, the same cure cycle as in comparative example 1 was implemented.

A bubble free white lens resulted. The lens cast with a wafer with no surface treatments resulted in massive bubbles. The lens produced using the hydrolyzed wafer had many bubbles, but less intensity than the lens with no surface treatments.

### COMPARATIVE EXAMPLE 3

Comparative example 1 is reproduced (with the longer cure cycle of 18 hours and 40 minutes), except that the polymerizable composition is a 1.60 refractive index polythiourethane composition as defined previously and except wafers were hydrolyzed at 40° C. in 5% NaOH at various times then dried at 45° C. A control was made where the wafers were soaked in de-ionized water. In all cases where a polarizing wafer was employed, a lens could not be made bubble free.

| NaOH soak | Dry at 45° C. | Comments |
|---|---|---|
| NA | NA | White lens, no bubbles |
| No | No | Massive bubbles |
| No | 30 minutes | Massive bubbles |
| 1 minute | No | Massive bubbles |
| 1 minute | 30 minutes | Massive bubbles |
| 5 minutes | No | Massive bubbles |
| 5 minutes | 30 minutes | Massive bubbles |
| 10 minutes | No | Massive bubbles |
| 10 minutes | 30 minutes | Massive bubbles |
| 30 minutes | 30 minutes | Many bubbles |
| 30 minutes | 1 hour | Many bubbles |
| 30 minutes | 2 hours | Many bubbles |
| 30 minutes | 3 hours | Many bubbles |
| 30 minutes | 4 hours | Many bubbles |
| 30 minutes | 5 hours | Many bubbles |

| Water soak | Dry at 45° C. | Comments |
|---|---|---|
| 10 minutes | No | Massive bubbles |
| 10 minutes | 30 minutes | Massive bubbles |

### COMPARATIVE EXAMPLE 4

Comparative example 3 is reproduced (18 hours and 40 minute cure cycle casting), except wafers were hydrolyzed at 40° C. in 5% NaOH for 30 minutes then dried for 24 hours as shown below.

| NaOH soak | Dry for 24 hours | Comments |
|---|---|---|
| 30 minutes | 45° C. | Many small sized bubbles |
| 30 minutes | 100° C. | Fewer small sized bubbles |

Extreme temperature and times were not able to eliminate the bubbles in the 18 hours and 40 minutes cure cycle process.

### EXAMPLE 5

Six wafers (1-6) were measured for surface tension resulting in a range of 66-72. Three (1-3) of these were hydrolyzed in 5% NaOH at 40° C. for 1 hour. Three (4-6) were not treated. It can be easily seen that the surface has been modified by the sharp reduction in contact angle to a range of 30-35.

| Sam- | | | | Aver- | | | | Aver- |
|---|---|---|---|---|---|---|---|---|
| ples | A | B | C | age | A1 | B1 | C1 | age |
| 1 | 65.77 | 67.85 | 66.93 | 67 | 34.88 | 36.47 | 33.43 | 35 |
| 2 | 70.59 | 72.48 | 72.52 | 72 | 30.15 | 32.23 | 28.56 | 30 |
| 3 | 69.41 | 67.21 | 68.50 | 68 | 31.98 | 28.51 | 30.35 | 30 |
| 4 | 64.93 | 65.69 | 66.75 | 66 | Dry only | Dry | Dry | Na |
| | | | | | | only | only | |
| 5 | 69.68 | 68.61 | 67.83 | 69 | Dry only | Dry | Dry | Na |
| | | | | | | only | only | |
| 6 | 67.64 | 67.01 | 67.53 | 67 | Dry only | Dry | Dry | Na |
| | | | | | | only | only | |

Lenses were cast as in Example 1, using a short cure method with a polythiourethane having a refractive index of around 1.67. Lenses 1-3 disassembled quite easily and intact from the molds. After edging to 54 mm, no separation of the layers occurred. No bubbles are observed. Upon the disassembly of lenses 4-6, on one of the lenses, the backside portion of the lens had no adhesion and broke apart. Another one of these lenses fell apart during disassembly and yet another fell apart after edging to a smaller diameter without even striking it on a hard surface. It is obvious that hydrolysis enhances adhesion of the layers.

Measurement of moisture present in a variety of polarizing wafers under their commercial forms are evaluated using TGA.

Three samples were submitted.

These were PVOH clad wafers.

The cladding materials were 1) CAB (Cellulose acetate butyrate), 2) CTA (cellulose triacetate), and 3) PC (polycarbonate). TGA (thermogravimetric analysis) was used to determine the amount of absorbed moisture.

### Measurement Techniques

A Versatherm High Sensitivity TGA was used for the % moisture determination. Between 20 and 43 mg of sample was used in the experiments. The temperature was ramped from ambient to 105° C. at 5° C. per minute. Then the sample was held at 105° C. for 30 minutes. The sample was purged with nitrogen. The change in mass was recorded throughout the duration of the experiment. The moisture content of the wafer materials was calculated as the difference in % wt between the initial mass and the equilibrium mass reached during the 105° C. isotherm.

### Results

Overall, the cellulose-based clad wafers experienced the greatest moisture loss. The change in mass associated with the moisture content of PET and PC clad wafers was an order of magnitude smaller than for the CAB and CTA wafers.

| | Mass | | |
|---|---|---|---|
| | Initial | Change | % |
| Sample | (mg) | (mg) | Change |
| CAB | 31.8824 | −0.3247 | −1.0 |
| CTA | 33.3387 | −0.6040 | −1.8 |
| PC | 42.4344 | −0.0221 | −0.1 |

### Sample 1—CAB

This sample experienced a net weight loss of 1.0% over the course of the TGA experiment. There was an initial increase in mass which likely arose from the absorption of water evolved from the sides of the furnace as it initially heated. Shortly thereafter, the mass decreased and the mass loss reached an equilibrium after the Sample 2—CTA

### Sample 2—CTA

This sample experienced a net weight loss of 1.8% over the course of the TGA experiment. This shows that the CTA absorbs more moisture than the CAB material. There was an initial increase in mass which likely arose from the absorption of water evolved from the sides of the furnace as it initially heated. Shortly thereafter, the mass decreased and the mass loss reached an equilibrium after the 105° C. isotherm was reached 105° C. isotherm was reached.

This clearly shows that the usual polarized wafers contain water or traces of water.

### Sample 3—PC

The PC clad material yielded a moisture loss associated with a 0.1% mass loss. The TGA data looks somewhat unstable, but the mass scale of the plot is very small compared to the other three samples so minor variations are exaggerated in this plot. Besides, the polycarbonate clad wafer is much thicker than the other wafers, therefore the % moisture loss is proportionally smaller.

1. A process for manufacturing a poly(thio)urethane-based optical article comprising the steps of:
disposing a polarizing film or wafer in a molding cavity of a two part mold assembly;
pouring a polymerizable composition comprising:
a) at least one polyiso(thio)cyanate monomer and at least one polyol and/or polythiol; or
b) a mixture of at least one liquid NCO and/or NCS terminated poly(thio)urethane prepolymer and at least one liquid OH and/or SH terminated poly(thio)urethane prepolymer;
c) with the proviso that the polymerizable composition has a ratio of NH₂ functionalities to the NCO or NCS functionalities of less than 0.9;
polymerizing the composition under such conditions that a hard gel is obtained in less than 30 minutes,
completing the polymerization,
opening the two part mold and recovering the bubble free optical article.

2. The process of claim 1, wherein the polymerizable composition is free of NH₂ functionalities.

3. The process of claim 1, wherein the hard gel is obtained in less than 20 minutes.

4. The process of claim 1, wherein the hard gel is obtained in less than 10 minutes.

5. The process of claim 1, wherein the polarizing film or wafer has a surface having a static contact angle with water ranging from 20° to 75°.

6. The process of claim 5, wherein the polarizing film or wafer has a surface having a static contact angle with water ranging from 25° to 35°.

7. The process of claim 1, wherein the polymerizable composition further comprises an anionic polymerization catalyst or catalyst system.

8. The process of claim 7, wherein the anionic polymerization catalyst or catalyst system comprises at least one salt selected form transition metals and ammonium salts of acids, these salts fulfilling the condition 0.5≦pKa≦14.

9. The process of claim 8, wherein the salts have formula:
Mₘ^{P+}Yₙ⁻
wherein,
M^{p+} is a cation selected from the group consisting of alkaline metals, alkaline earth metals, transitions metals and ammonium groups of formula NR⁺₄ in which R is an alkyl radical,
Y⁻ is an anion such that the corresponding acid YH has a pKa fulfilling the condition 0.5≦pKa≦14,
p is the valency of the cation, and
n=m×p.

10. The process of claim 9, wherein the cation of the salts are selected from the group consisting of Li⁺, Na⁺, K⁺, R^{b+}, Mg²⁺, Ca²⁺, Ba²+ and Al³⁺.

11. The process of claim 9, wherein the NR₄+ groups are those in which R is a C₁-C₈ alkyl radical.

12. The process of claim 9, wherein the anion Y⁻ is selected from the group consisting of thiocyanate, carboxylate, thiocarboxylate, acetylacetonate, diketone, acetoacetic ester, malonic ester, cyanoacetic ester, ketonitrile and anion of formula RS⁻ wherein R is a substituted or non-substituted alkyl group or phenyl group.

13. The process of claim 9, wherein the anion Y⁻ is SCN⁻, acetylacetonate, acetate, thioacetate, formate or benzoate.

14. The process of claim 9, wherein the salt is KSCN.

15. The process of claim 8, wherein the catalyst system further comprises at least one electro-donor compound.

16. The process of claim 15, wherein the electro-donor compound is selected from the group consisting of acetonitrile compounds, amide compounds, sulfones, sulfoxides, trialkylphosphites, nitro compounds, ethyleneglycol ethers, crown ethers and kryptates

17. The process of claim 15, wherein the electro-donor compound is selected from 18-crown-6, 18-crown-7,15-crown-5 and 15-crown-6.

18. The process of claim 8, further comprising a solvent of the catalyst or catalyst system.

19. The process of claim 1, wherein the polymerizable composition comprises a mixture of polyisocyanate[s]monomer[s] and polythiol[s]monomer[s].

20. The process of claim 1, wherein the polymerizable composition comprises a mixture of at least two polythiourethane prepolymers, one of the prepolymer being a NCO terminated prepolymer and the other being a SH terminated prepolymer.

21. The process of claim 1, wherein the polarizing wafer is a laminated wafer consisting of a PVOH (polyvinyl alcohol) polarizing layer supported on both sides with CAB layers.

22. The process of claim 1, wherein the polarizing film or wafer is previously hydrolyzed, preferably by immersion in a NaOH or HCl aqueous solution.

23. The process of claim 22, wherein immersion is effected at a temperature ranging for room temperature to 50° C.

24. The process of claim 22, wherein the polarizing film or wafer immersion is effected in 5% NaOH aqueous solution at a temperature of about 40° C.

25. The process of claim 24, wherein immersion lasts for about 30 minutes.
